(19) United States
(12) Patent Application Publication
(10) Pub. No.: US 2006/0059976 A1
(43) Pub. Date: Mar. 23, 2006

(54) Accelerometer with real-time calibration

(75) Inventors: Dmitri V. Simonenko, Potomac Falls, VA (US); Anton E. Suprun, Novosibirsk (RU); Yuri I. Romanov, Novosibirsk (RU)

Correspondence Address: STERNE, KESSLER, GOLDSTEIN & FOX P.L.L.C., 1100 NEW YORK AVE., N.W., WASHINGTON, DC, 20005, US

(73) Assignee: Innalabs Technologies, Inc., Dulles, VA (US)

(21) Appl. No.: 10/992,289

(22) Filed: Nov. 19, 2004

Related U.S. Application Data
(63) Continuation-in-part of application No. 10/980,791, filed on Nov. 4, 2004.
(60) Provisional application No. 60/616,849, filed on Oct. 8, 2004.
(60) Provisional application No. 60/614,415, filed on Sep. 30, 2004.
(60) Provisional application No. 60/613,723, filed on Sep. 29, 2004.
(60) Provisional application No. 60/612,227, filed on Sep. 23, 2004.

(51) Int. Cl. G01P 21/00

(52) U.S. Cl. 73/1.38

(57) ABSTRACT

A method of calibrating an acceleration sensor includes suspending an inertial body using a magnetic fluid; generating a magnetic field within the magnetic fluid; modulating the magnetic field to cause a displacement of the inertial body; measuring a response of the inertial body to the modulation; and calibrating the acceleration sensor in real time based on the measurement. Current can be driven through a plurality of magnets for generating the magnetic field so as to create the modulation. Sensing coils can be used for detecting the response of the inertial body. The modulation can be periodic, an impulse or some other aperiodic function.

### CROSS-REFERENCE TO RELATED APPLICATIONS

This application is a continuation-in-part of U.S. application Ser. No. 10/980,791, entitled MAGNETOFLUIDIC ACCELEROMETER WITH ACTIVE SUSPENSION, filed Nov. 4, 2004.

This application claims priority to U.S. Provisional Patent Application No. 60/616,849, entitled MAGNETOFLUIDIC ACCELEROMETER AND USE OF MAGNETOFLUIDICS FOR OPTICAL COMPONENT JITTER COMPENSATION, Inventors: SUPRUN et al., Filed: Oct. 8, 2004; U.S. Provisional Patent Application No. 60/614,415, entitled METHOD OF CALCULATING LINEAR AND ANGULAR ACCELERATION IN A MAGNETOFLUIDIC ACCELEROMETER WITH AN INERTIAL BODY, Inventors: ROMANOV et al., Filed: Sep. 30, 2004; U.S. Provisional Patent Application No. 60/613,723, entitled IMPROVED ACCELEROMETER USING MAGNETOFLUIDIC EFFECT, Inventors: SIMONENKO et al., Filed: Sep. 29, 2004; and U.S. Provisional Patent Application No. 60/612,227, entitled METHOD OF SUPPRESSION OF ZERO BIAS DRIFT IN ACCELERATION SENSOR, Inventor: Yuri I. ROMANOV, Filed: Sep. 23, 2004; which are all incorporated by reference herein in their entirety.

This application is related to U.S. patent application Ser. No. 10/836,624, filed May 3, 2004; U.S. patent application Ser. No. 10/836,186, filed May 3, 2004; U.S. patent application Ser. No. 10/422,170, filed May 21, 2003; U.S. patent application Ser. No. 10/209,197, filed Aug. 1, 2002, now U.S. Pat. No. 6,731,268; U.S. patent application Ser. No. 09/511,831, filed Feb. 24, 2000, now U.S. Pat. No. 6,466,200; and Russian patent application No. 99122838, filed Nov. 3, 1999, which are all incorporated by reference herein in their entirety.

### BACKGROUND OF THE INVENTION

1. Field of the Invention

The present invention is related to acceleration sensors, and more particularly, to real-time calibration of acceleration sensors while the sensor is in use.

2. Background Art

Magnetofluidic accelerometers are described in, e.g., U.S. patent application Ser. No. 10/836,624, filed May 3, 2004, U.S. patent application Ser. No. 10/836,186, filed May 3, 2004, U.S. patent application Ser. No. 10/422,170, filed May 21, 2003, U.S. patent application Ser. No. 10/209,197, filed Aug. 1, 2002 (now U.S. Pat. No. 6,731,268), U.S. patent application Ser. No. 09/511,831, filed Feb. 24, 2000 (now U.S. Pat. No. 6,466,200), and Russian patent application No. 99122838, filed Nov. 3, 1999. These accelerometers utilize magnetofluidic principles and an inertial body suspended in a magnetic fluid, to measure acceleration. Such an accelerometer often includes a sensor casing (sensor housing, or “vessel”), which is filled with magnetic fluid. An inertial body (“inertial object”) is suspended in the magnetic fluid. The accelerometer usually includes a number of drive coils (power coils) generating a magnetic field in the magnetic fluid, and a number of measuring coils to detect changes in the magnetic field due to relative motion of the inertial body.

When the power coils are energized and generate a magnetic field, the magnetic fluid attempts to position itself as close to the power coils as possible. This, in effect, results in suspending the inertial body in the approximate geometric center of the housing. When a force is applied to the accelerometer (or to whatever device the accelerometer is mounted on), so as to cause angular or linear acceleration, the inertial body attempts to remain in place. The inertial body therefore “presses” against the magnetic fluid, disturbing it and changing the distribution of the magnetic fields inside the magnetic fluid. This change in the magnetic field distribution is sensed by the measuring coils, and is then converted electronically to values of linear and angular acceleration. Knowing linear and angular acceleration, it is then possible, through straightforward mathematical operations, to calculate linear and angular velocity, and, if necessary, linear and angular position. Phrased another way, the accelerometer provides information about six degrees of freedom—three linear degrees of freedom (x, y, z), and three angular (or rotational) degrees of freedom (αₓ, α_{y}, α_{z}).

Stability of sensor characteristics is an important factor in a system design. Sensor characteristics can change over time, either due to temporary environmental effects, or due to permanent changes in characteristics of various sensor components. For example, such environmental factors as temperature and humidity can affect sensor performance, by introducing an error into the output of the sensor. Such an error may disappear once the particular environmental parameter (temperature or humidity) reverts to some narrower operating range.

Other parameters may involve permanent changes to sensor properties. For example, the properties of the magnetic fluid can change over time. The properties of various mechanical components, such as the housing or the magnets, can also change. Dimensional tolerances can worsen, due to repeated shock and vibration. Some of the magnetic fluid might leak out, even if in minute quantities, creating an air bubble inside the volume that is supposed to be entirely filled with the magnetic fluid. All of these factors degrade sensor performance.

Conventional calibration approaches typically calibrate the sensor after manufacture, or after the sensor has been installed in a system, but do not provide for real-time calibration of the sensor. Accordingly, there is a need in the art for a sensor that can be calibrated repeatedly, including calibrated during operation.

### BRIEF SUMMARY OF THE INVENTION

The present invention relates to an accelerometer with real-time calibration that substantially obviates one or more of the disadvantages of the related art.

More particularly, in an exemplary embodiment of the present invention, a method of calibrating an acceleration sensor includes suspending an inertial body using a magnetic fluid; generating a magnetic field within the magnetic fluid; modulating the magnetic field to cause a displacement of the inertial body; measuring a response of the inertial body to the modulation; and calibrating the acceleration sensor based on the measurement. Current can be driven through a plurality of magnets for generating the magnetic field so as to create the modulation. Sensing coils, inductive coils, Hall sensors, or other means can be used for detecting the response of the inertial body. The modulation can be periodic, an impulse or some other aperiodic function. The modulation can also be ultrasonic.

In another aspect, a method for calibrating an accelerometer includes suspending an inertial body in a fluid; applying a predetermined force to the inertial body; measuring behavior of the inertial body in response to the applied force; and calibrating the accelerometer in real time as a function of the measured behavior.

In another aspect, a method of calibrating an accelerometer includes suspending an object using a fluid; generating a magnetic field within the fluid; delivering a stimulus to the inertial body to cause a displacement of the inertial body; measuring a response of the inertial body to the stimulus; and calibrating an accelerometer based on the measurement.

In another aspect, a method of calibrating an acceleration sensor includes suspending an inertial body using a fluid; generating a magnetic field within the fluid; continuously calculating the acceleration based on changes of the magnetic field; and calibrating the acceleration sensor in real time without interrupting normal functioning of the sensor. The calibrating step causes a predetermined displacement of the inertial body. An ultrasonic stimulus can causes the predetermined displacement. Alternatively, drive magnets can be driven to cause the predetermined displacement.

In another aspect, a sensor includes an inertial body, a plurality of magnets located generally around the inertial body, and a magnetic fluid between the magnets and the inertial body. A first circuit modulates magnetic fields generated by the magnets to calibrate the sensor in real time. A second circuit measures acceleration based on displacement of the inertial body. The acceleration can have components of linear and/or angular acceleration.

In another aspect, a sensor includes an inertial body, a plurality of magnets generating a repulsive force acting on the inertial body, and a controller that modulates magnetic fields generated by the magnets so as displace the inertial body. A controller calculates a response of the sensor to applied acceleration based on the displacement and calibrates the sensor in real time. The controller derives the acceleration as a function of a current required by the magnetic poles to modulate the magnetic fields. The inertial body is non-magnetic or weakly magnetic. The controller includes a bandpass filter centered at approximately a frequency of the modulation. A low pass filter can be used to filter out a frequency of the modulation when calculating acceleration.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an isometric three-dimensional view of an assembled magneto fluidic acceleration sensor of the present invention.

FIG. 2 illustrates a side view of the sensor with one of the drive magnet assemblies removed.

FIG. 3 illustrates a partial cutaway view showing the arrangements of the drive magnet coils and the sensing coils.

FIG. 4 illustrates an exploded side view of the sensor.

FIG. 5 illustrates a three-dimensional isometric view of the sensor of FIG. 4, but viewed from a different angle.

FIG. 6 illustrates one approach to real-time calibration of an accelerometer.

FIG. 7 illustrates the arrangment of electronics used for real-time calibration of the sensor.

### DETAILED DESCRIPTION OF THE INVENTION

Reference will now be made in detail to embodiments of the present invention, examples of which are illustrated in the accompanying drawings.

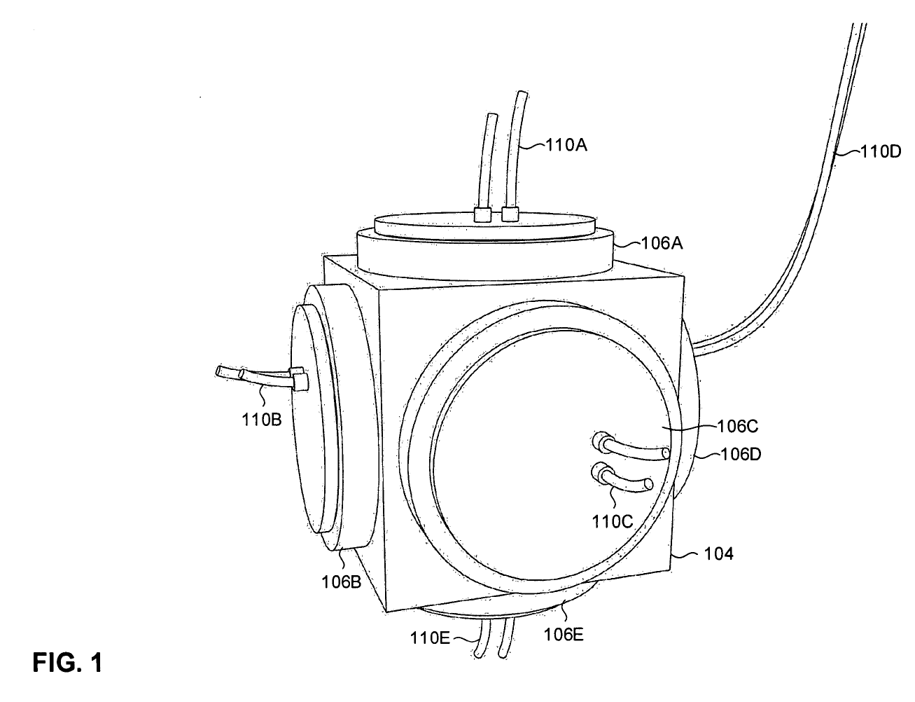

FIG. 1 illustrates an exemplary embodiment of a magnetofluidic acceleration sensor of the present invention. The general principles of operation of the magnetofluidic sensor are described in U.S. Pat. No. 6,466,200, which is incorporated herein by reference. The sensor's behavior is generally described by a set of non-linear partial differential equations, see U.S. Provisional Patent Application No. 60/614,415, entitled METHOD OF CALCULATING LINEAR AND ANGULAR ACCELERATION IN A MAGNETOFLUIDIC ACCELEROMETER WITH AN INERTIAL BODY, Inventors: ROMANOV et al., Filed: Sep. 30, 2004, to which this application claims priority.

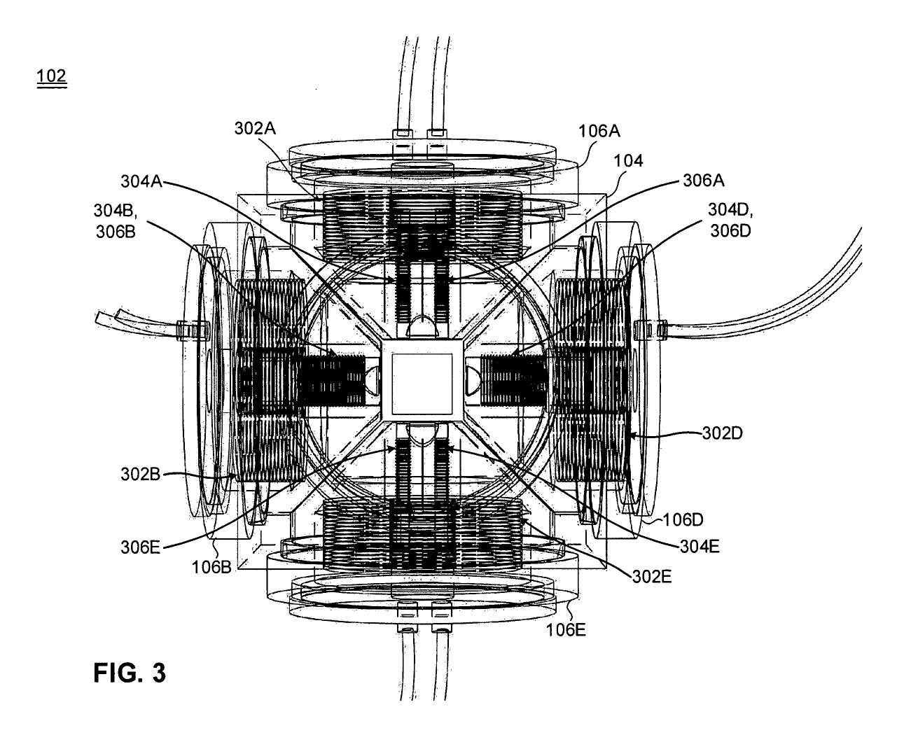

Further with reference to FIG. 1, the accelerometer 102, shown in FIG. 1 in assembled form, includes a housing 104, a number of drive magnet assemblies 106A-106E, each of which is connected to a power source using corresponding wires 110A-110E. Note that in this view, only five drive magnet assemblies 106 are shown, but see FIG. 3, where a sixth drive magnet assembly (designated 106F) is also illustrated.

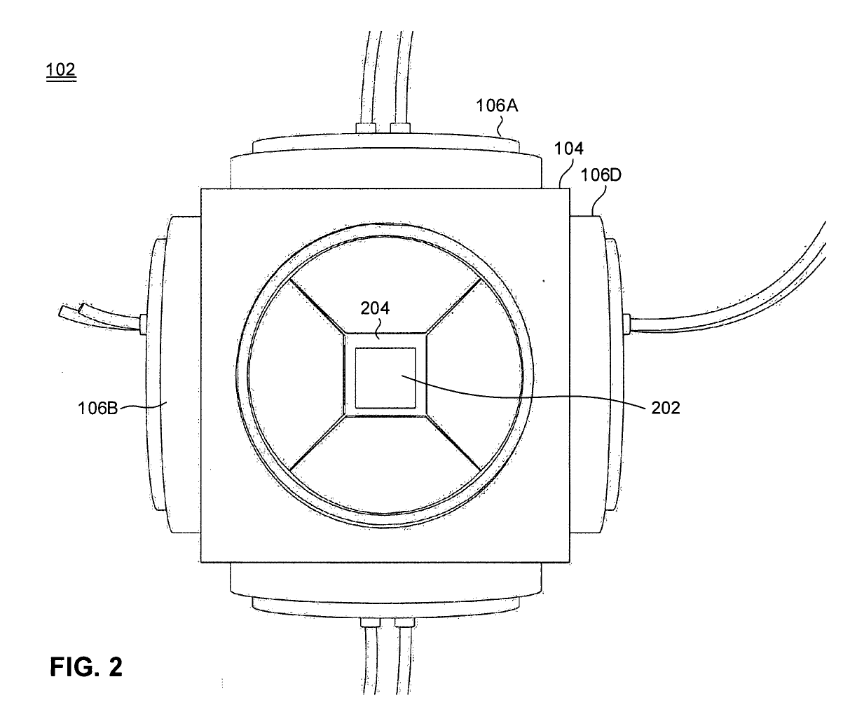

FIG. 2 illustrates the sensor 102 of FIG. 1, with one of the drive magnet assemblies removed. With the drive magnet assembly 106C removed, an inertial body 202 is visible in an approximate geometric center of the housing 104. The magnetic fluid 204 fills the remainder of the available volume within the housing. Note that the magnetic fluid itself is not actually drawn in the figure for clarity, although most such fluids are black in color and have an “oily” feel to them.

FIG. 3 illustrates a partial cutaway view showing the arrangements of the drive magnet coils and the sensing coils. Only some of the components are labeled in FIG. 3 for clarity. Shown in FIG. 3 are four drive coils (or drive magnets) 302A, 302B, 302E and 302D, collectively referred to as drive magnets 302 (the remaining two drive magnets are not shown in this figure). The drive magnets 302 are also sometimes referred to as suspension magnets, power magnets, or suspension coils (if electromagnets are used).

In one embodiment, each such drive magnet assembly 106 has two sensing coils, designated by 306 and 304 (in FIG. 3, 306A, 304A, 306B, 304B, 306E, 304E, 306D, 304D). The sensing coils 306, 304 are also sometimes referred to as “sensing magnets,” or “measuring coils.”

Note further that in order to measure both linear and angular acceleration, two sensing coils per side of the “cube” are necessary. If only a single sensing coil were to be positioned in a center of each side of the “cube,” measuring angular acceleration would be impossible. As a less preferred alternative, it is possible to use only one sensing coil per side of the cube, but to displace it off center. However, the mathematical analysis becomes considerably more complex in this case.

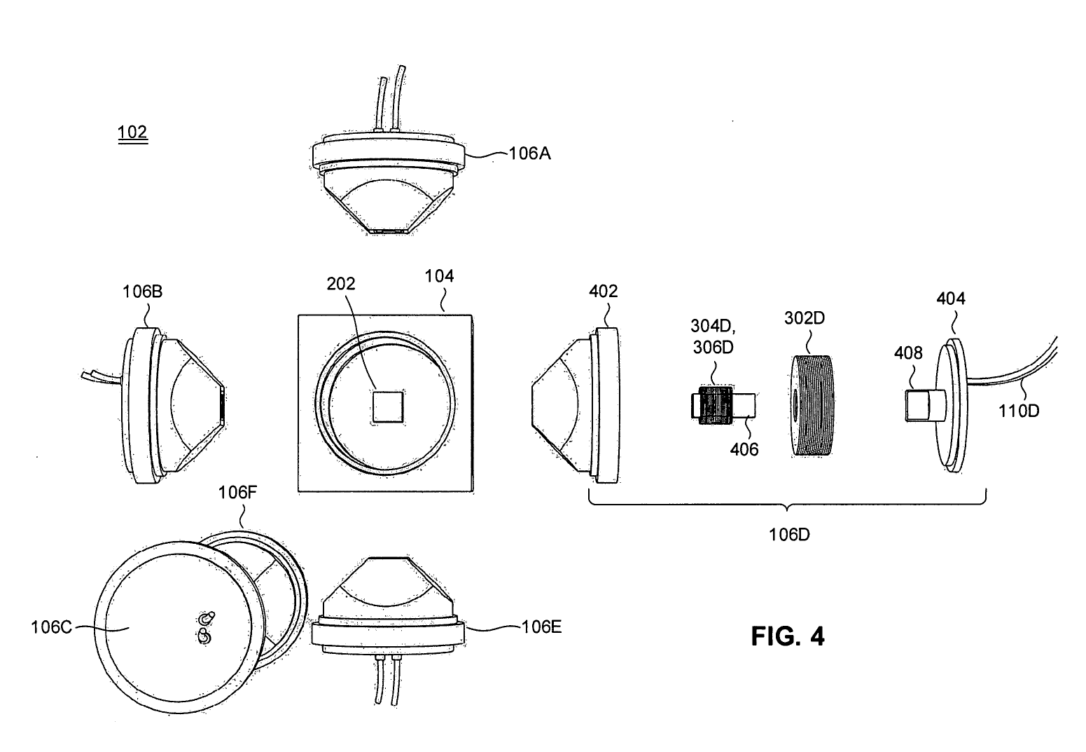

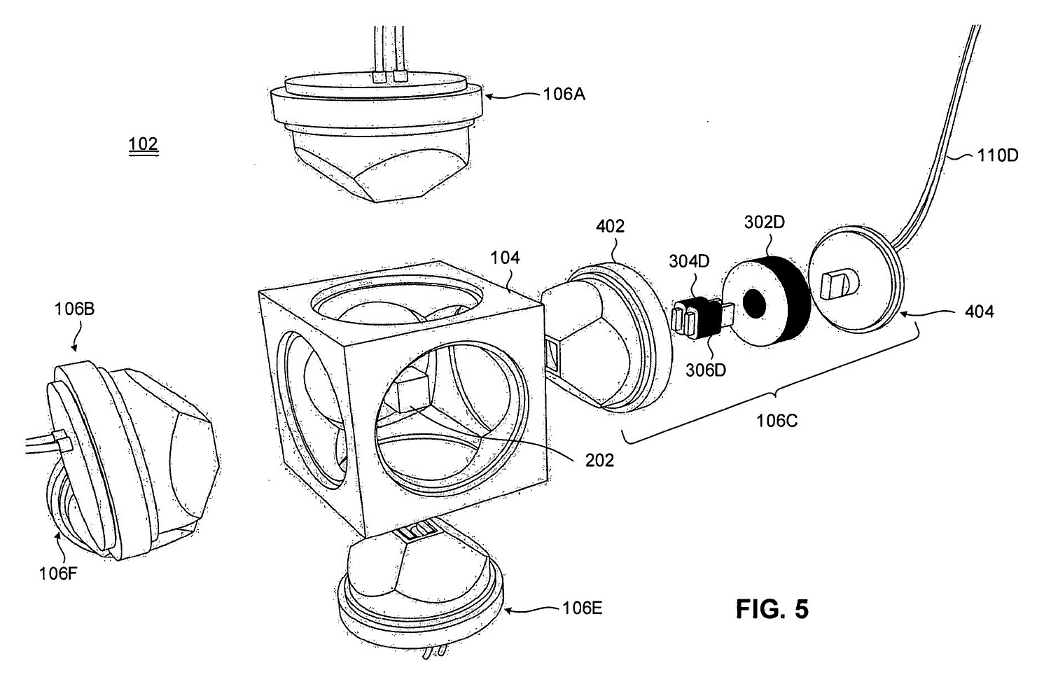

FIGS. 4 and 5 illustrate exploded views of the sensor 102, showing the same structure from two different angles. In particular, shown in FIGS. 4 and 5 is an exploded view of one of the drive magnet assembly 106D. As shown in the figures, the drive magnet assembly 106D includes a casing 402, a rear cap 404, the drive coil 302D, two sensing coils 306D and 304D, magnet cores 406 (one for each sensing coil 306D and 304D), and a drive magnet core 408. In an alternative embodiment, the cores 406 and 408 can be manufactured as a single common piece (in essence, as a single “transformer core”).

In this embodiment, the sensing coils 306D and 304D are located either inside the drive coil 302D, and the rear cap 404 holds the drive coil 302D and the sensing coils 306D and 304D in place in the drive coil assembly 106D, or alternatively, the sensing coils 306D and 304D can be either partially or entirely forward of the drive coil 302D.

The drive magnets 302 are used to keep the inertial body 202 suspended in place. The sensing coils 306, 304 measure the changes in the magnetic flux within the housing 104. The magnetic fluid 204 attempts to flow to locations where the magnetic field is strongest. This results in a repulsive force against the inertial body 202, which is usually either non-magnetic, or partly (weakly) magnetic (e.g., substantially less magnetic than the magnetic fluid 204).

The sensor 102 described and illustrated above thus works on the principle of repulsive magnetic forces. The magnetic fluid 203 is highly magnetic, and is attracted to the drive magnets 302. Therefore, by trying to be as close to the drive magnets 302 as possible, the magnetic fluid in effect “pushes out,” or repels, the inertial body 202 away from the drive magnets 302. In the case where all the drive magnets 302 are identical, or where all the drive magnets 302 exert an identical force, and the drive magnets 302 are arranged symmetrically about the inertial body 202, the inertial body 202 will tend to be in the geometric center of the housing 104. This effect may be thought of as a repulsive magnetic effect (even though, in reality, the inertial body 202 is not affected by the drive magnets 302 directly, but indirectly, through the magnetic fluid 204).

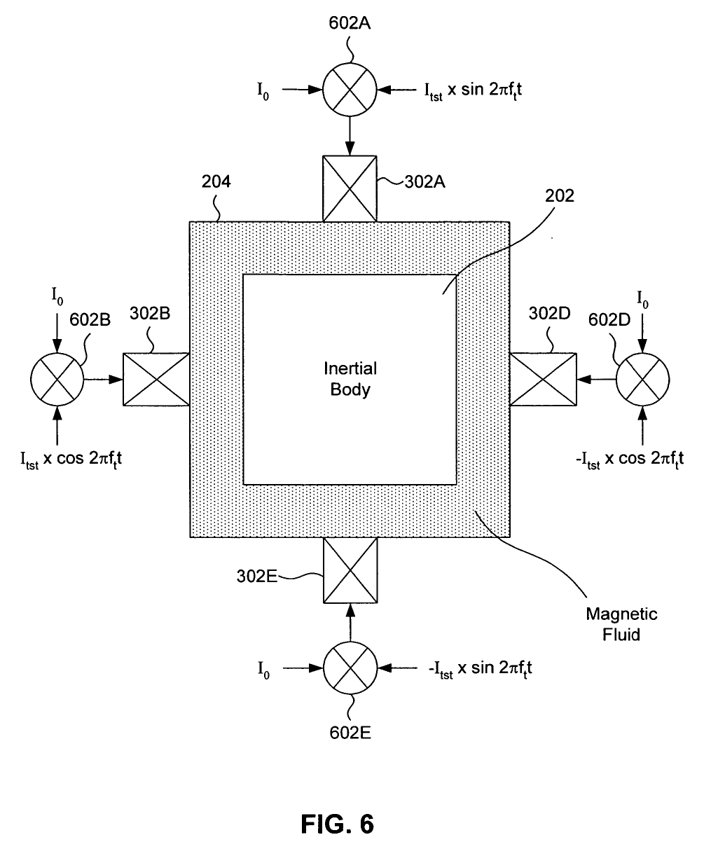

FIG. 6 illustrates one approach to real time calibration of the sensor 102. Shown in FIG. 6 is the inertial body 202 and magnetic fluid 204. The housing 104 is not shown in this figure for clarity. Also shown in FIG. 6 are four drive magnets 302A, 302B, 302D and 302E. Only four of the six drive magnets are shown in this figure for clarity. In this case, the drive magnets 302 are shown as electromagnets only, although the invention is not limited to this embodiment, and the drive magnets 302 can also be a combination of an electromagnet and a permanent magnet. Each drive magnet 302 is driven by a DC current, designated by I₀. If the sensor 102 is symmetric, then the current I₀ through each drive magnet 302 will be the same. If the sensor 102 is asymmetric (for example, a brick-like housing 104 shape, or some other abritrary non-symmetrical shape), then the nominal DC current I₀ may be different for the various drive magnets 302.

Also shown in FIG. 6 are summers 602A, 602B, 602D and 602E, for the corresponding drive magnets 302A, 302B, 302D, 302E, respectively. The summers 602 sum the DC current I₀ and the testing, or stimulus, current Iₜₛₜ modulated by a periodic function (e.g., either a sine or a cosine with a frequency fₜ). Thus, each drive magnet 302 is driven both by a DC current I₀ and the testing current Iₜₛₜ×sin (2πfₜt) with the phases of the test currents as shown in FIG. 6.

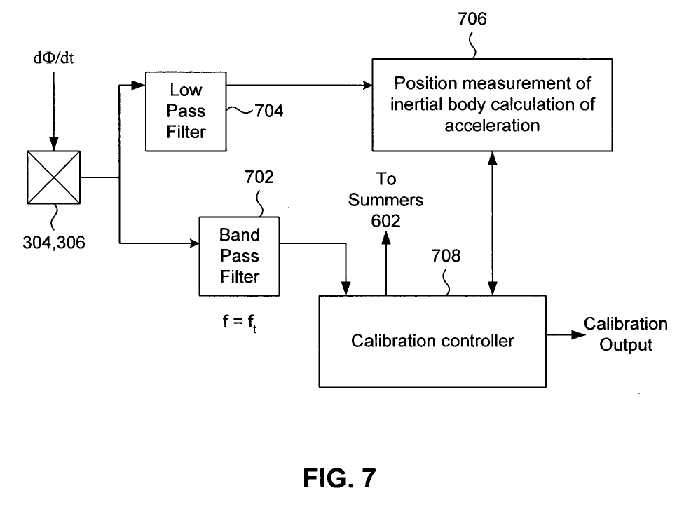

FIG. 7 illustrates the arrangment of electronics used for real time calibration of the sensor 102. As shown in FIG. 7, the changes

$$\frac{ⅆ Φ}{ⅆ t}$$

in the magnetic flux density Φ within the sensor 102 are detected by the sensing coils 304, 306. The outputs of the sensing coils 302, 306 are fed through a lowpass filter 704 or through a band pass filter 702. The low pass filter 704, which is optional, can be used to filter out any unwanted frequency components, such as high frequency vibration. It can also be used to filter out the effects of the calibration (i.e., to filter out the response of the sensor 102 at fₜ). The band pass filter 702 is centered around the test frequency fₜ. It is generally preferable, although not necessary, to select a testing frequency fₜ that is higher than any expected vibration that the sensor 102 needs to detect, given the particular application. For example, fₜ may be higher than the low pass filter 704 will permit through it.

Position measurement electronics 706 calculates the position of the inertial body 202, based on the output of the sensing coils (or other position sensors), and from the position of the inertial body 202, derives linear and angular acceleration. A calibration controller 708 receives the output of the band pass filter 702, which represents the movement of the inertial body 202 due to the applied calibration stimulus Iₜₛₜ. The calibration controller 708 also outputs control signals to the summers 602, so as to drive the drive magnets 302 in the predictable manner.

By knowing the expected effect of the stimulus Iₜₛₜ×sin (2πfₜt) on the inertial body 202, and comparing the predicted response of the inertial body 202 with an actual response, the sensor 102 can be calibrated in real time, without taking the sensor 102 (or the device that uses the sensor 102) offline. Note that with the test frequency fₜ higher than any expected intput frequency, there is no reason why the applied stimulus Iₜₛₜ will affect measurement of acceleration by the sensor 102. Note also that the preferred amplitude of the stimulus is on the order of 5-10% of the dynamic range of the sensor 102.

Although in the description above, drive magnets 302 are used to deliver a known stimulus to the sensor 102, this need not be the case. For example, an ultrasonic stimulus can also be used. A source of ultrasonic vibration can be mounted on the housing 104 (not shown in the figures) (or even inside the housing 104), and controlled to deliver a known stimulus to the inertial body 202. With the response measured and compared to the expected (or previously measured) response, the sensor 102 can be calibrated, in a manner similar to discussed above.

Although a periodic sine-wave type stimulus is discussed above, other signal shapes can be used, such as step functions, impulse functions, aperiodic functions, square waves, and others.

The output of the calibration controller 704 can then be used by the rest of the sensor electronics, to apply a correction factor to the output of the sensor 102. Alternatively, or in addition, the DC currents I₀ can be changed or adjusted in response to the calibration. As an alternative, the calibration controller 708 can force the inertial body 202 to be displaced by a given amount, and measure the “effort” (i.e., the required current) needed to do so (and compare that “effort” to the expected effort), thereby deriving the calibration factor.

Having thus described embodiments of the invention, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. A method of calibrating an acceleration sensor comprising:
suspending an inertial body using a magnetic fluid;
generating a magnetic field within the magnetic fluid;
modulating the magnetic field to cause a displacement of the inertial body;
measuring a response of the inertial body to the modulation; and
calibrating the acceleration sensor based on the measurement.

2. The method of claim 1, further comprising driving current through a plurality of magnets for generating the magnetic field.

3. The method of claim 1, further comprising using sensing coils for detecting the response of the inertial body.

4. The method of claim 1, wherein the modulation comprises periodic modulation.

5. The method of claim 1, wherein the modulation comprises an impulse.

6. A method for calibrating an accelerometer comprising:
suspending an inertial body in a fluid;
applying a predetermined force to the inertial body;
measuring behavior of the inertial body in response to the predetermined force; and
calibrating the accelerometer in real time as a function of the measured behavior.

7. The method of claim 6, wherein the force comprises a periodic force.

8. The method of claim 6, wherein the force comprises an impulse.

9. A method of calibrating an accelerometer comprising:
suspending an object using a fluid;
generating a magnetic field within the fluid;
delivering a stimulus to the object to cause a displacement of the object;
measuring a response of the object to the stimulus; and
calibrating an accelerometer based on the measurement.

10. The method of claim 9, wherein the stimulus comprises a periodic waveform.

11. The method of claim 9, wherein the stimulus comprises an impulse.

12. The method of claim 9, wherein the stimulus is an ultrasonic stimulus.

13. The method of claim 9, wherein the step of delivering a stimulus comprises modulating a plurality of drive magnets.

14. A method of calibrating an acceleration sensor comprising:
suspending an inertial body using a fluid;
generating a magnetic field within the fluid;
continuously calculating the acceleration based on changes of the magnetic field; and
calibrating the acceleration sensor in real time without interrupting normal functioning of the sensor.

15. The method of claim 14, wherein the calibrating step provides a predetermined change to the magnetic field.

16. The method of claim 15, further comprising modulating the magnetic field generated by electromagnets to cause the predetermined change to the magnetic field.

17. The method of claim 14, wherein the calibrating step causes a predetermined displacement of the inertial body.

18. The method of claim 17, wherein an ultrasonic stimulus causes the predetermined displacement.

19. A sensor comprising:
an inertial body;
a plurality of magnets located generally around the inertial body;
a fluid between the magnets and the inertial body;
a first circuit that modulates magnetic fields generated by the magnets to calibrate the sensor in real time; and
a second circuit that measures acceleration based on displacement of the inertial body.

20. The sensor of claim 19, wherein the second circuit measures the acceleration based on an output of a plurality of sensing coils.

21. The sensor of claim 19, wherein the acceleration includes linear acceleration.

22. The sensor of claim 19, wherein the acceleration includes angular acceleration.

23. The sensor of claim 19, wherein the magnets further comprise permanent magnets.

24. The sensor of claim 19, wherein the fluid is a magnetic fluid.

25. A sensor comprising:
an inertial body;
a plurality of magnets generating a repulsive force acting on the inertial body;
a controller that modulates magnetic fields generated by the magnets so as to displace the inertial body; and
a circuit that calculates a response of the inertial body to applied acceleration based on the displacement.

26. The sensor of claim 25, wherein the controller derives the acceleration as a function of a current required by the magnets to modulate the magnetic fields.

27. The sensor of claim 25, further comprising sensing coils for detecting the displacement of the inertial body.

28. The sensor of claim 25, wherein the inertial body is non-magnetic.

29. The sensor of claim 25, wherein the inertial body is weakly magnetic.

30. The sensor of claim 25, wherein the circuit comprises a bandpass filter centered at approximately a frequency of the modulation.

31. The sensor of claim 25, further comprising a low pass filter to filter out a frequency of the modulation when calculating acceleration due to external forces.

32. The sensor of claim 31, wherein the circuit applies a correction factor to the calculated acceleration based on an output of the controller.

33. An acceleration sensor comprising:
an inertial body;
a fluid exerting a force on the inertial body;
a plurality of magnets generating magnetic fields within the fluid;
position sensors detecting a change in position of the inertial body due to acceleration; and
a controller that drives the magnets so as to generate a predetermined movement of the inertial body,
wherein the acceleration sensor is calibrated in real time based on measurement of the predetermined movement by the position sensors.

34. The method of claim 33, wherein the fluid is a magnetic fluid.

35. The method of claim 33, wherein the fluid is a ferrofluid.

36. A method of calibrating an accelerometer comprising:
suspending an object using a fluid;
generating a magnetic field within the fluid;
causing a predetermined displacement of the inertial body;
measuring a force necessary to cause the predermined displacement; and
calibrating an accelerometer based on the measurement.

37. A method of calibrating an acceleration sensor comprising:
suspending an inertial body using a magnetic fluid;
generating a magnetic field within the magnetic fluid;
modulating the magnetic field to displace the inertial body in a predetermined manner;
measuring a required modulation for causing the displacement; and
calibrating the acceleration sensor based on the required modulation.
